(19) United States
(12) Patent Application Publication
(10) Pub. No.: US 2018/0056221 A1
(43) Pub. Date: Mar. 1, 2018

(54) FILTER DEVICE AND OXYGEN ENRICHING APPARATUS

(71) Applicant: Breath Technology Co., Ltd., Bunkyo-ku, Tokyo (JP)

(72) Inventor: Hideaki TSUTSUMI, Saitama (JP)

(21) Appl. No.: 15/555,320

(22) PCT Filed: Feb. 25, 2016
(86) PCT No.: PCT/JP2016/055579

§ 371 Date: Sep. 1, 2017

(30) Foreign Application Priority Data
Mar. 2, 2015 (JP) 2015-040271

(51) Int. Cl. B01D 46/00; A62B 7/10; A62B 7/08; B01D 46/10; B01D 46/48; B01D 53/047; B01D 51/10; C01B 13/02

(52) U.S. Cl. CPC B01D 46/0068; C01B 2210/0046; A62B 7/08; B01D 46/0056; B01D 46/10; B01D 46/48; B01D 53/047; B01D 51/10; C01B 13/0259; B01D 2275/202; B01D 2279/40; B01D 2253/108; B01D 2256/12; B01D 2257/102; C01B 2210/0014; A62B 7/10

(57) ABSTRACT

In a filter device, a disc-shaped filter is disposed on a main flow channel through which a gas flows, and the filter is rotated by a motor. A branch flow channel branches off at the downstream of the filter in the main flow channel, and branched gas is passed through the filter in an opposite direction. Rotation of the filter moves dust collected in a dust gathering region where the filter and the main flow channel overlap with each other to a cleaning region where the filter and the branch flow channel overlap with each other so that the dust is disengaged from the filter. Thus, the filter of the filter device can be automatically cleaned.

### TECHNICAL FIELD

The present invention relates to a filter device for cleaning gases, and an oxygen enriching apparatus employing the filter device.

### BACKGROUND ART

In various machines or electrical apparatuses in conventional techniques, such as air conditioners, oxygen enrichers, servers, and projectors, the inside thereof is cooled by the circulation of a gas such as air, or a gas, such as air, itself is utilized. Such a main unit often employs a filer device for cleaning dust contained in the gas. In this filter device, a filter is disposed along a flow channel of the gas, and the dust is trapped by the filter. Clogging of the filter occurs when the filter is used for a certain period of time.

To avoid such filter clogging, there is a filter device with a cleaning mechanism for automatically cleaning a filter periodically (see Japanese Patent Application Laid-Open No. 2011-245460). According to this cleaning mechanism, a rotary brush for collecting dust is brought into contact with the filter, and the rotary brush and the filter are moved relative to each other. Consequently, dust attached to the filter is removed by the rotation of the brush. The dust collected by the brush is collected in a collecting box. This cleaning operation is automatically performed intermittently every time a certain period of time elapses.

### SUMMARY OF INVENTION

### Technical Problem

According to the cleaning mechanism of the conventional filter device, however, there is a problem that not all dust on the filter is collected by the brush, and part of the dust tends to remain on the filter. Moreover, since the filter stops functioning during the cleaning operation, the cleaning needs to be performed not during the operation of the main unit but at the timing of turning ON or OFF of a power source.

Moreover, a demand for reducing the operation sound of the main unit as much as possible is frequently heard. In the conventional filter device, however, there is a problem that the sound of a fan (blower) therein is more likely to leak to the outside via the filter.

Furthermore, along with the miniaturization of various apparatuses in recent years, the downsizing of the filter device has been demanded. The conventional cleaning mechanism, however, needs a space for disposing the brush and a space for relatively moving the brush and the filter. This makes it difficult to achieve the downsizing of the filter device.

The present invention has been made in view of the aforementioned problems, and it is an object of the present invention to provide a filter device, etc., capable of sufficiently collecting dust on a filter and saving space.

### Solution to Problem

One aspect of the present invention to achieve the aforementioned object provides a filter device including: a main flow channel through which a gas flows; a disc-shaped filter disposed on the main flow channel, with the gas passing through the disc-shaped filter in one direction; a motor configured to rotate the filter; and a branch flow channel disposed downstream of the filter in the main flow channel, the branch flow channel being configured to allow part of the gas in the main flow channel to branch off and allow the branched gas to pass through the filter in the other direction thereof. Rotation of the filter moves dust collected by the filter in a dust gathering region where the filter and the main flow channel overlap with each other to a cleaning region where the filter and the branch flow channel overlap with each other, so that the dust is disengaged from the filter.

In association with the above-described filter device, a region downstream of the cleaning region in the branch flow channel extends in a planar direction of the filter.

In association with the above-described filter device, the filter is disposed so that a rotation axis thereof is directed horizontally, and the region downstream of the cleaning region in the branch flow channel extends in a vertical direction.

In association with the above-described filter device, a region upstream of the dust gathering region in the main flow channel extends in a planar direction of the filter.

In association with the above-described filter device, the filter is disposed so that a rotation axis thereof is directed horizontally, and the region upstream of the dust gathering region in the main flow channel extends in a vertical direction.

In association with the above-described filter device, a region upstream of the dust gathering region in the main flow channel extends in a planar direction of the filter, a region downstream of the cleaning region in the branch flow channel extends in the planar direction of the filter, and the main flow channel and the branch flow channel extending in the planar direction of the filter at least partially overlap with each other as viewed in an orthogonal direction to the rotation axis of the filter.

In association with the above-described filter device, the gas and the dust are released vertically downward at downstream of the branch flow channel.

In association with the above-described filter device, a dust collecting box is detachably disposed downstream of the cleaning region in the branch flow channel, and a collection filter configured to allow the gas to pass therethrough and gather the dust is disposed in the dust collecting box.

In association with the above-described filter device, the collection filter constitutes a bottom surface of the dust collecting box.

In association with the above-described filter device, a main flow channel cover unit disposed upstream of the filter in the main flow channel to face the dust gathering region with a distance from the filter is included, and the main flow channel cover unit guides a gas on an upstream side in the main flow channel in a planar direction of the filter.

In association with the above-described filter device, the main flow channel cover unit is detachably disposed, and disengagement of the main flow channel cover unit causes at least part of the filter to be exposed to outside.

In association with the above-described filter device, a guide unit disposed closely to face the filter at a place upstream of the filter in the main flow channel and not overlapping with the dust gathering region is included, and the guide unit guides the gas in the main flow channel in a planar direction of the filter to the dust gathering region.

In association with the above-described filter device, a branch channel cover unit disposed downstream of the filter in the branch flow channel to face the cleaning region with a distance from the filter is included, and the branch channel cover unit guides a gas on a downstream side in the branch flow channel in a planar direction of the filter.

In association with the above-described filter device, a suction space disposed downstream of the filter in the main flow channel, a pressurization space disposed downstream of the suction space in the main flow channel, and gas transfer means configured to transfer a gas in the suction space to the pressurization space are included, and branching of the branch flow channel is formed in the pressurization space.

Another aspect of the present invention to achieve the aforementioned object provides an oxygen enriching apparatus equipped with the filter device according to any one of those described above.

### Advantageous Effects of Invention

The filter device, etc., according to the present invention can reliably collect dust while reducing user's maintenance burden. Moreover, space saving can be achieved in the filter device.

### BRIEF DESCRIPTION OF DRAWINGS

FIG. 1(A) is a front view illustrating a filter device according to an embodiment of the present invention, and FIG. 1(B) is a front view illustrating the filter device from which a cover member has been detached.

FIG. 2 is a rear view illustrating the filter device.

FIG. 3(A) is a side cross-sectional view of the filter device viewed along arrows “A-A” in FIG. 1, FIG. 3(B) is a side cross-sectional view of the filter device viewed along arrows “B-B” in FIG. 1, FIG. 3(C) is a side cross-sectional view of the filter device viewed along arrows “C-C” in FIG. 1, FIG. 3(D) is a plane cross-sectional view of the filter device viewed along arrows “D-D” in FIG. 1, and FIG. 3(E) is a plane cross-sectional view of the filter device viewed along arrows “E-E” in FIG. 1.

FIG. 4 is a perspective view illustrating the filter device.

FIG. 5 is an exploded perspective view illustrating the filter device.

FIG. 6(A) is a front cross-sectional view illustrating an oxygen enricher to which the filter device is applied, and FIG. 6(B) is a side cross-sectional view illustrating the oxygen enricher.

FIGS. 7(A) to 7(D) are perspective views each illustrating an application example of a dust collecting box in the filter device.

FIG. 8 is a perspective view illustrating an application example of the dust collecting box in the filter device.

### DESCRIPTION OF EMBODIMENTS

An embodiment of the present invention will be described below in detail with reference to the drawings.

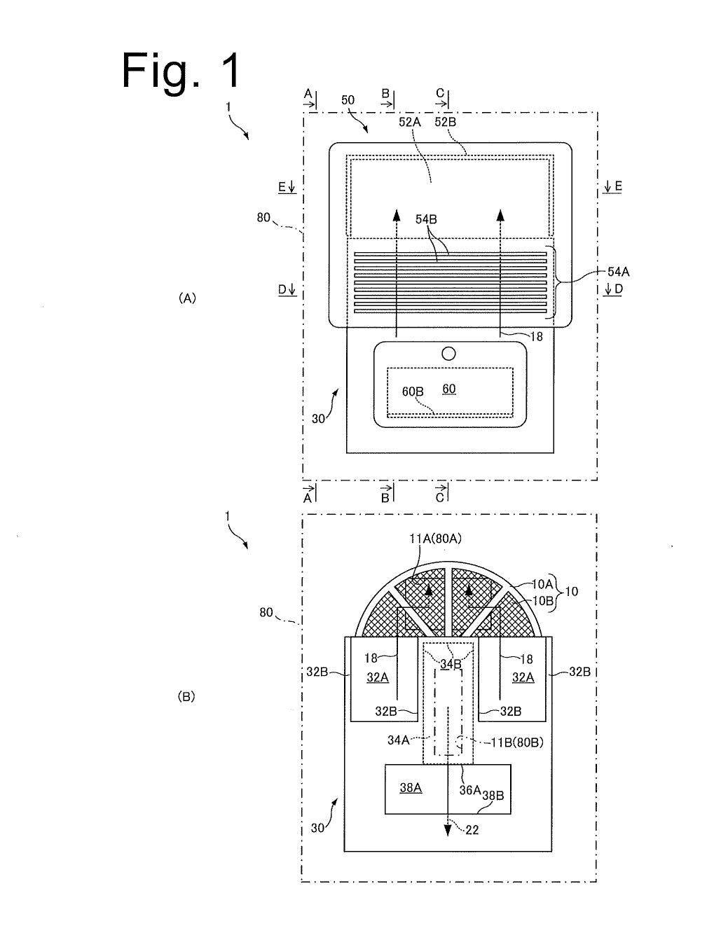

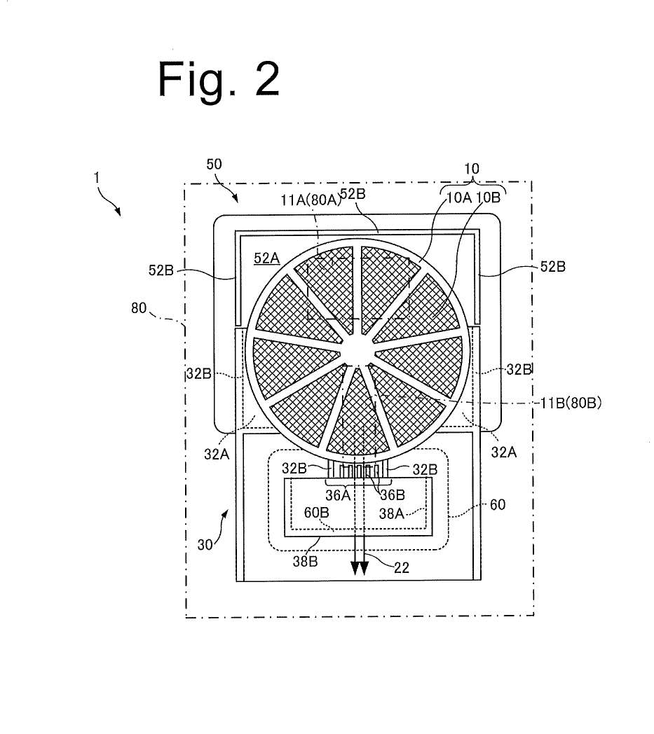

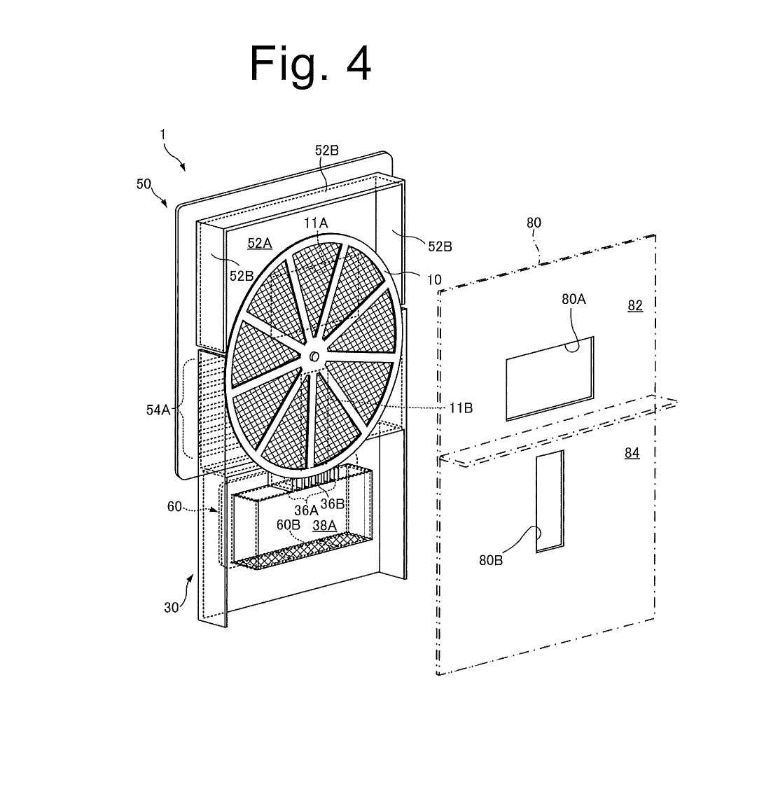

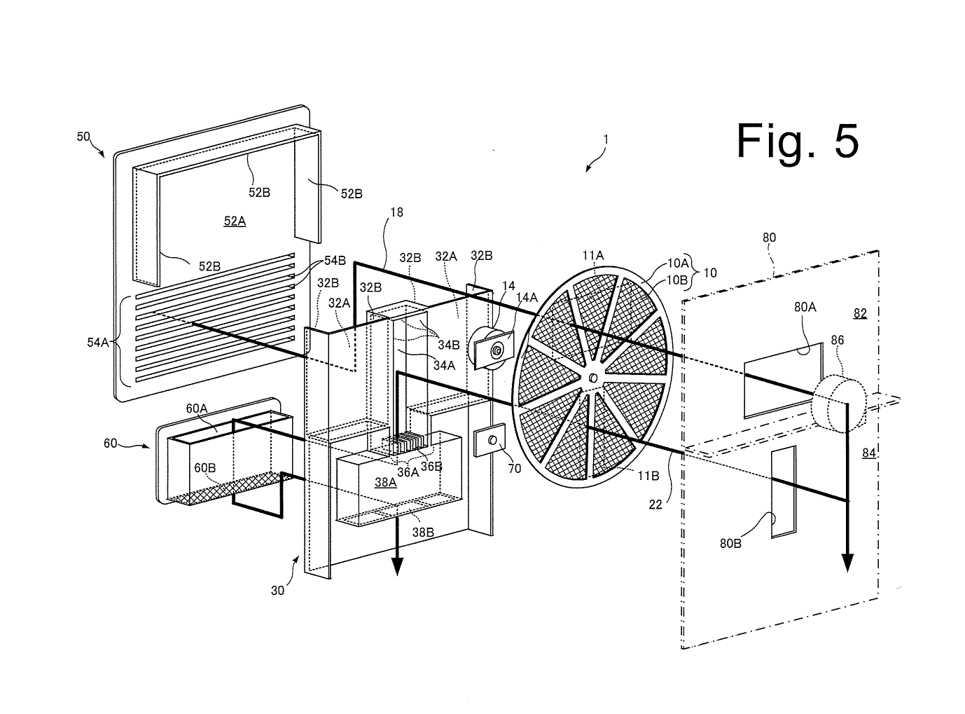

A filter device 1 according to an embodiment of the present invention is shown in FIGS. 1 to 5. As shown in an exploded view of FIG. 5, the filter device 1 includes: a disc-shaped filter 10; a motor 14 configured to rotate the filter 10; a main flow channel 18 through which a gas (air) flows; a branch flow channel 22 through which a cleaning gas (air) flows; a first flow channel forming member 30; a cover member 50; a dust collecting box 60; operation detecting means 70; and a second flow channel forming member 80.

The main flow channel 18 is a passage through which a gas containing dust flows, and the gas is passed through a dust gathering region 11A of the filter 10 to gather the dust. The gas from which the dust has been removed is utilized for various purposes. Thus, according to the filter device 1, an apparatus main body that requires the present filter device 1 is disposed downstream of the main flow channel 18.

The branch flow channel 22 is a flow channel branched off from the main flow channel 18 at the downstream of the filter 10 in the main flow channel 18. The gas is passed through a cleaning region 11B of the filter 10 to remove and collect the dust gathered by the filter 10. Part of the gas flowing through the main flow channel 18 flows into the branch flow channel 22. A direction in which the gas passes through the cleaning region 11B in the branch flow channel 22 is opposite to a direction in which the gas passes through the dust gathering region 11 in the gas main flow channel 18.

The filter 10 includes: a ring-shaped frame member 10A having radial spokes; and a mesh member 10B fixed to the frame member. The gas is passed through the mesh member 10B to trap the dust contained in the gas. The filter 10 is disposed so that the rotation axis thereof is directed horizontally. In other words, a planar surface of the filter 10 extends in vertical and horizontal directions. In a space in which the filter 10 is disposed, the dust gathering region 11A overlapping with the main flow channel 18 and the cleaning region 11B overlapping with the branch flow channel 22 are formed. As a material of the filter 10 (the frame member 10A and the mesh member 10B), a metal such as iron or stainless steel or a resin may be employed. In the case of a metal, an insulative film or insulative coating is preferably applied to a surface of the metal to prevent electric leakage to a housing.

The second flow channel forming member 80 is a plate member disposed close to an inner side (a side closer to the apparatus main body is herein defined as the inner side) of the filter 10. The second flow channel forming member 80 includes a main flow channel opening 80A and a branch flow channel opening 80B, which face the filter 10. An area of the main flow channel opening 80A is larger than an area of the branch flow channel opening 80B. The main flow channel opening 80A defines the dust gathering region 11A of the filter 10, and the branch flow channel opening 80B defines the cleaning region 11B of the filter 10.

Furthermore, a dimension of the main flow channel opening 80A in a horizontal direction (a circumferential direction of the filter 10) is larger than a dimension thereof in an up-down direction (a radial direction of the filter 10) in a range of the upper half of the filter 10. A dimension of the branch flow channel opening 80B in the up-down direction (the radial direction of the filter 10), on the other hand, is larger than a dimension thereof in the horizontal direction (the circumferential direction of the filter 10) in a range of the lower half of the filter 10. Moreover, the dimension of the branch flow channel opening 80B in the radial direction is set larger than the dimension of the main flow channel opening 80A in the radial direction. Thus, when the dust collected by the filter 10 through the use of the dust gathering region 11A moves to the cleaning region 11B by the rotation of the filter 10, the whole range of the dust gathering region 11A in the radial direction can be covered by the cleaning region 11B. Therefore, insufficient collection of the dust is prevented from occurring.

A suction space 82 is formed downstream of the second flow channel forming member 80 in the main flow channel 18. Moreover, a pressurization space 84 is formed further downstream of the suction space 82 in the main flow channel 18. Gas transfer means 86 configured to transfer the gas from the suction space 82 to the pressurization space 84 is disposed between the suction space 82 and the pressurization space 84. Examples of the gas transfer means 86 include a fan, a blower, and a pump. The gas transfer means 86 forcibly moves the gas from the suction space 82 to the pressurization space 84. Consequently, the suction space 82 is turned into a negative pressure state. The negative pressure causes a gas to flow into the suction space 82 from the outside via the main flow channel 18. The pressurization space 84, on the other hand, is turned into a positive pressure state. The positive pressure causes the branch flow channel 22 to branch off from the main flow channel 18 in the pressurization space 84. Thus, the positive pressure in the pressurization space 84 causes part of the gas in the main flow channel 18 to be released to the outside of the filter 10 via the branch flow channel 22.

The filter 10 is fixed to the rotation axis of the motor 14, and thus the motor 14 directly rotates the filter 10. The motor 14 is fixed to the first flow channel forming member 30 via a bracket 14A.

The operation detecting means 70 herein utilizes a photodetector, and detects the rotation of the filter 10 through the use of a difference in optical reflectance or optical transmittance between the spoke member 10A and the mesh member 10B in the filter 10. Specifically, a reflective photointerrupter is employed. By being fixed to the first flow channel forming member 30, the reflective photointerrupter detects a difference in optical reflectance between the spoke member 10A and the mesh member 10B and thereby recognizes a rotational state of the filter 10. When abnormal rotation of the filter 10 occurs, a controller, which is not specifically shown in the figure, issues an alarm. Alternatively, a light-emitting unit and a light-receiving unit may be disposed on both sides of the filter 10 as the operation detecting means 70, and the rotation of the filter 10 may be detected on the basis of a difference in optical transmittance in the filter 10. Alternatively, an encoder may be installed in the motor 14, thereby enabling the direct detection of the rotation of a motor shaft. Any other place capable of facing the filter 10 may be used as a place to install the operation detecting means 70.

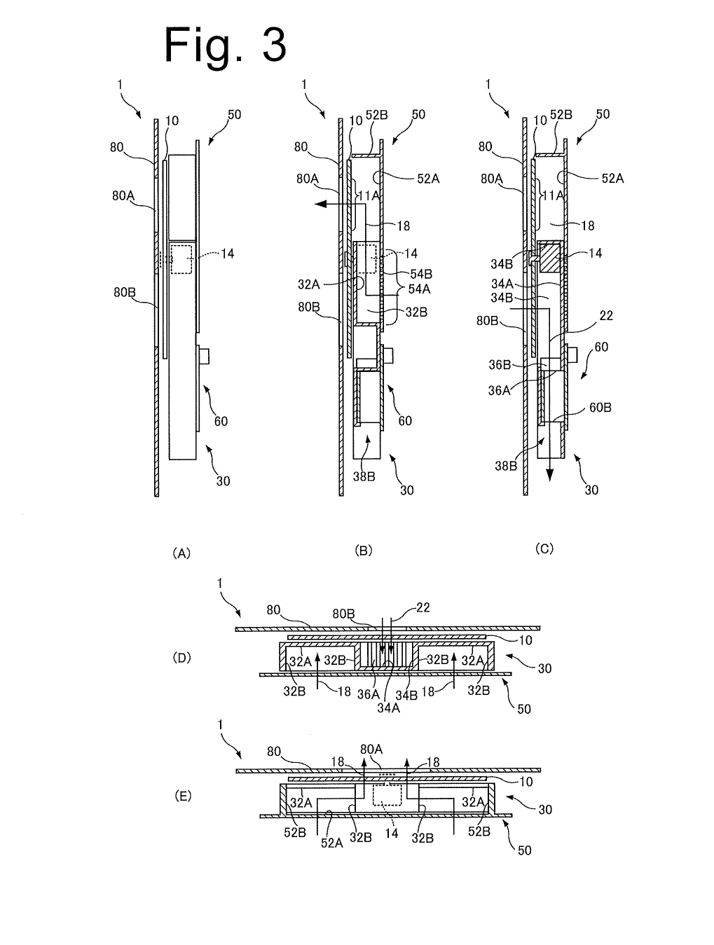

The first flow channel forming member 30 is disposed on an outer side (upstream side with reference to the main flow channel 18) of the filter 10. The first flow channel forming member 30 includes a pair of guide plates (guide units) 32A. The guide plate 32A is disposed closely to face the filter 10 at a place not overlapping with the dust gathering region 11A when the filter 10 is viewed in a direction perpendicular to the plane thereof. The guide plate 32A herein is a plate-shaped member extending in the vertical direction, and constitutes part of the main flow channel 18 at the upstream of the filter 10. Consequently, a gas flows in a planar direction (vertically upward direction) along the guide plate 32A, and the gas is guided to the dust gathering region 11A of the filter 10. Side walls 32B are formed on both sides in the gas-flowing direction in each guide plate 32A (both sides in the horizontal direction). The gas is guided by the side walls 32B in the vertical direction to the dust gathering region 11A without escaping into the outside (see FIG. 1(B) and FIG. 3(B), for example).

The first flow channel forming member 30 further includes a branch channel cover plate (branch channel cover unit) 34A disposed to face the cleaning region 11B with a distance from the filter 10. The branch channel cover plate 34A is a plate-shaped member extending in the vertical direction, and constitutes part of the branch flow channel 22 at the downstream of the filter 10. The gas having passed through the cleaning region 11B of the filter 10 in the direction perpendicular to the plane thereof collides against the branch channel cover plate 34A, thus changing its traveling direction (making a turn) to the planar direction. Note that a total of three side walls 34B are formed on both sides in a direction (vertically downward direction) in which the gas flows along the branch channel plate 34A (both sides in the horizontal direction) and at an edge in a direction opposite to the gas-flowing direction (upper end). Thus, the branch channel cover plate 34A constitutes a flow channel by being surrounded by the three side walls 34B, and guides the gas in the vertically downward direction. In the present embodiment, a pair of main flow channels 18, which are constituted by the guide plates 32A, are disposed on both sides of the branch flow channel 22, which is constituted by the branch channel cover plate 34A, in the horizontal direction (see FIG. 1(B)). Thus, a single plate-shaped member extending in the vertical direction doubles as the side wall 34B on either side of the branch channel cover plate 34A and the inner side wall 32B of the guide plate 32A.

Therefore, the upstream side in the main flow channel 18 (see FIG. 3(B)) and the downstream side in the branch flow channel 22 (see FIG. 3(C)) partially overlap with each other when the first flow channel forming member 30 is viewed in the horizontal direction and in a direction orthogonal to the rotation axis of the filter 10. Thus, the filter device 1 can be made extremely thin. In the present embodiment, the motor 14 is housed in an upper part of a space surrounded by the branch channel cover plate 34A and the three side walls 34B.

As shown in FIG. 5, an opening 36A is formed at a downstream end (i.e., a vertical lower end) of the branch channel cover plate 34A in the first flow channel forming member 30. The gas having passed through the branch flow channel 22 is released downwardly from the opening 36A. The opening 36A is provided with a barrier member 36B to prevent a finger from being inserted into the inside of the opening 36A and touching the cleaning region 11B of the filter 10 for safety reasons.

An insertion space 38A of the dust collecting box 60 is formed downstream (i.e., the vertically lower side) of the opening 36A in the first flow channel forming member 30. A surface of the insertion space 38A opposite to the filter 10 is opened, and the dust collecting box 60 is detachably inserted into the insertion space 38A through the opening. A bottom surface 38B of the insertion space 38A has a breathable member or is made breathable. Specifically, the bottom surface 38B is provided with a barrier or a grating. Consequently, the gas released into the insertion space 38A from the opening 36A can pass through (be released from) the bottom surface 38B downwardly (to the outside).

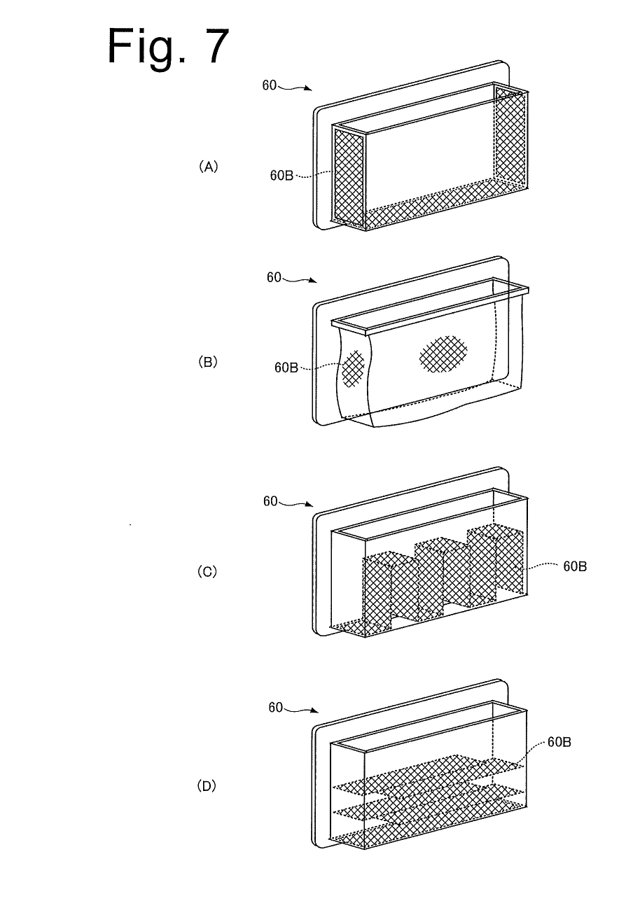

The dust collecting box 60 includes a gas intake port 60A formed in an upper surface thereof, and a collection filter 60B formed in a bottom surface thereof. The gas intake port 60A faces the opening 36A when disposed in the insertion space 38A, and takes the gas released from the opening 36A into the box. The collection filter 60B on the bottom surface is made of a net-like material to allow for the passage of the gas therethrough and gather dust (i.e., the dust attached to the cleaning region 11B of the filter 10) contained in the gas. Since the collection filter 60B faces the bottom surface 38B of the insertion space 38A, the gas having passed through the collection filter 60B is released to the outside via the bottom surface 38B of the insertion space 38A. The collection filter 60B is detachable and the collected dust can be easily washed away. When an area of the collection filter 60 is small, the collection filter 60 may be disposed on a front surface, a rear surface, or a side surface in addition to the bottom surface as shown in FIG. 7(A). Alternatively, the dust collecting box 60 may be configured, for example, as a frame structure as shown in FIG. 7(B), and a mesh bag may be disposed therein so that the mesh bag itself serves as the collection filter 60. Alternatively, a collection area is preferably increased by making a wave-shaped collection filter 60 as shown in FIG. 7(C) or a labyrinth-shaped collection filter 60 as shown in FIG. 7(D), for example.

The cover member 50 is a member to externally cover the filter 10 and the first flow channel forming member 30. The cover member 50 includes a main flow channel cover plate (main flow channel cover unit) 52A extending in the vertical direction and the horizontal direction. The main flow channel cover plate 52A herein is a plate-shaped member extending in the horizontal and vertical directions. The main flow channel cover plate 52A is disposed upstream of the filter 10 in the main flow channel 18 to face the dust gathering region 11A with a distance from the filter 10. A total of three side walls 52B are formed on both sides in a direction (vertically downward direction) in which the gas flows in the main flow channel cover plate 52A (both sides in the horizontal direction) and at one edge (upper end) in the gas-flowing direction. The side walls 52B may be made of a porous material such as sponge or urethane having high sound absorbability.

In the main flow channel 18 constituted by the main flow channel cover plate 52A and the three side walls 52B, the gas is guided vertically upward to collide against the three side walls 52B. Consequently, the gas makes a turn in the horizontal direction, thus changing its direction toward the dust gathering region 11A. Note that the guide plates 32A and the side walls 32B in the first flow channel forming member 30 are continuously provided upstream (vertically lower side) of the main flow channel 18 constituted by the main flow channel cover plate 52A and the three side walls 52B. Thus, the gas guided vertically upward by the guide plate 32A, for example, flows into the main flow channel cover plate 52A side.

The cover member 50 includes a gas intake plate 54A continuous with the main flow channel cover plate 52A. The gas intake plate 54A faces the guide plates 32A of the first flow channel forming member 30 with a gap (flow channel) being provided therebetween. The gas intake plate 54A is provided with a plurality of ventilation slits 54B, and a gas is taken in from the ventilation slits 54B. The introduced gas is guided to the dust gathering region 11A of the filter 10 through the guide plates 32A and the main flow channel cover plate 52A previously mentioned.

The cover member 50 is disposed detachably from the first flow channel forming member 30 or the apparatus main body. Thus, when the cover member 50 is detached, an area including the dust gathering region 11A of the filter 10 is mainly exposed. Thus, in periodic maintenance work of the filter 10, the filter 10 can be wiped with a cloth or the like simply by detaching the cover member 50.

Operations of the filter device 1 and gas flows will be described next.

In the filter device 1, a gas flows through the main flow channel 18, and part of the gas branches off into the branch flow channel 22. Consequently, dust contained in the gas flowing through the main flow channel 18 is gathered in the dust gathering region 11A where the main flow channel 18 and the filter 10 overlap with each other. The rotation of the filter 10 by the motor 14 conveys the dust gathered in the dust gathering region 11A to the cleaning region 11B. Since the flow direction of the branch flow channel 22 is opposite to that of the main flow channel 18, the dust is disengaged by the gas in the cleaning region 11B, thus achieving automatic cleaning of the filter 10. The rotation of the filter 10 by the motor 14 may be constant-speed rotation or may be intermittent rotation with a given time interval.

The filter 10 is disposed so that the rotation axis thereof is directed horizontally. The downstream side in the branch flow channel 22 running in the rotation axis direction (horizontal direction) of the filter 10 makes a turn in the planar direction (vertically downward) of the filter 10. Thus, the gas having collected the dust attached to the filter 10 in the cleaning region 11B makes a turn vertically downward by the branch flow channel 22 and is released from the opening 36A at the downstream end into the dust collecting box 60. The gas is further released downwardly from the collection filter 60B on the bottom surface of the dust collecting box 60. At this time, the dust is gathered again by the collection filter 60B. Thus, the gas released from the collection filter 60B to the outside is in a clean state containing no dust. Since the dust collecting box 60 is installed detachably, the collection filter 60B can be always kept clean by detaching the dust collecting box 60 periodically and discarding the dust gathered by the collection filter 60B. Needless to say, the collection filter 60B is preferably washed with water or the like periodically.

As described above, the region downstream of the cleaning region 11B in the branch flow channel 22 extends in the planar direction (vertically downward) of the filter 10 along the flow direction of the gas. Thus, even if internal operation sound of the gas transfer means 86 passes through the cleaning region 11B, such sound collides against the branch channel cover plate 34A. Thus, the internal noise is less likely to leak from the filter device 1 to the outside. The dust collecting box 60 also has a configuration in which the internal noise is less likely to leak in the lateral direction because the gas is discharged from the bottom surface side.

The region upstream of the filter 10 in the main flow channel 18 also extends in the planar direction (vertically up-down direction) of the filter 10 along the flow direction of the gas. In other words, the gas having passed through the gas intake plate 54A in the horizontal direction ascends by traveling vertically upward and makes a turn again in the rotation axis direction (horizontal direction) of the filter 10 at the upper end to pass through the dust gathering region 11A of the filter 10. Even if the internal operation sound of the gas transfer means 86 passes through the dust gathering region 11A, the flow channel having such a crank configuration enables the sound to collide against the main flow channel cover plate 52A. Thus, the internal noise is less likely to leak from the filter device 1 to the outside directly.

Furthermore, the upstream side in the main flow channel 18 and the downstream side in the branch flow channel 22 (collectively expressed as flow channels on the outer side of the filter 10) extend in the planar direction of the filter 10 as mentioned above. These flow channels, however, are formed to overlap with each other as viewed in a side surface direction. Thus, the filter device 1 can be made extremely thin while achieving silent design.

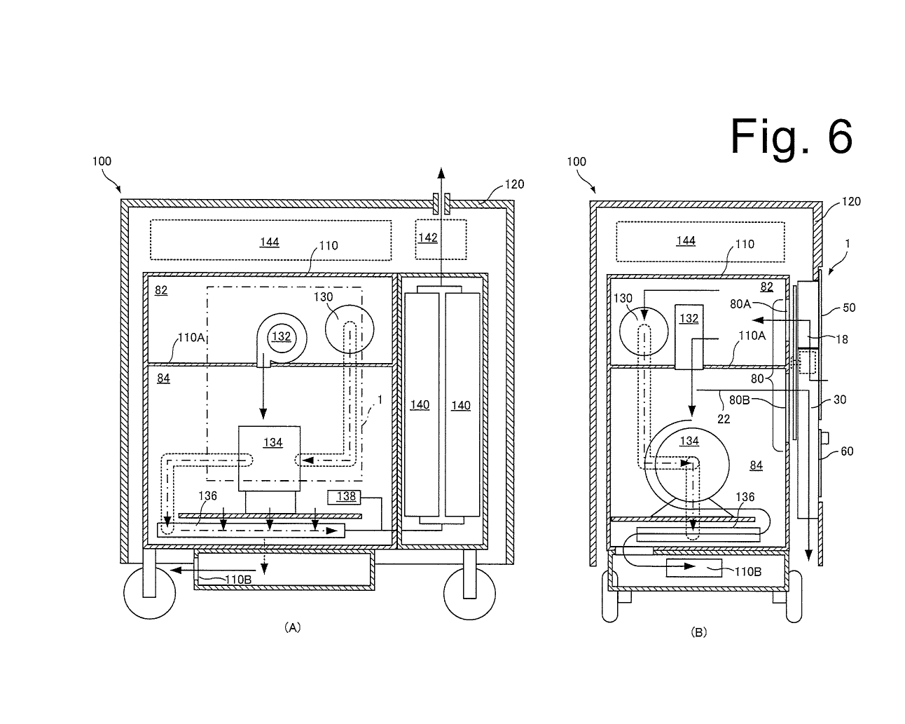

With reference to FIG. 6, an oxygen enriching apparatus 100 will be described next as an example of a main unit equipped with the above-described filter device 1. The oxygen enriching apparatus 100 includes the filter device 1, a housing 110, an external cover 120, a HEPA filter 130, a blower 132, a compressor 134, a heat exchanger 136, a silencer 138, an oxygen enriching mechanism 140, a humidification mechanism 142, and a controller 144.

The filter device 1 is installed in a gap between the housing 110 and the external cover 120 on a rear surface side of the oxygen enriching apparatus 100. The cover member 50 of the filter device 1 constitutes part of the external cover 120. Also, the second flow channel forming member 80 of the filter device 1 doubles as part of the housing 110.

A partition member 110A in the horizontal direction separates the inside of the housing 110 into the suction space 82 and the pressurization space 84 in the up-down direction. The external cover 120 covers side surfaces and an upper surface of the housing 110.

The blower 132 is installed between the suction space 82 and the pressurization space 84. The blower 132 takes a gas into the suction space 82 from the outside via the filter device 1 and forcibly ejects the gas vertically downward toward the pressurization space 84. The compressor 134 is disposed immediately below the blower 132 in the pressurization space 84. The gas ejected from the blower 132 cools the compressor 132 when passing through the circumference of the compressor 132. The HEPA filter 130 is installed in the suction space 82. The HEPA filter 130 takes in the gas in the suction space 82 to remove dust and supplies the purged gas to the compressor 132 via piping illustrated with dotted lines.

The compressor 132 compresses the gas supplied from the HEPA filter 130, and then supplies the compressed gas to the oxygen enriching mechanism 140 via the heat exchanger 136. The oxygen enriching mechanism 140 herein employs what is called a PSA method, and nitrogen is removed from the compressed gas by a pair of adsorption towers storing zeolite. The oxygen enriching mechanism 140 supplies the gas in which oxygen is enriched by the removal of nitrogen to the outside via the humidification mechanism 142. The silencer 138 is disposed in the pressurization space 84. The silencer 138 is connected to the oxygen enriching mechanism 140 to periodically discharge nitrogen adsorbed by the adsorption towers into the pressurization space 84, thereby refreshing the oxygen enriching mechanism 140. The controller 144 controls all of these devices.

The heat exchanger 136 is disposed closer to a bottom surface of the housing 110. The gas ejected from the blower 132 passes through the outer surface of the compressor 132 and further passes through the outer surface of the heat exchanger 136. This cools the compressed gas passing through the inside of the heat exchanger 136.

The bottom surface of the housing 110 is provided with an exhaust hole 110B, and the gas having cooled the compressor 132 and the heat exchanger 136 is exhausted therefrom. Note that the gas having passed through the branch flow channel 22 and the dust collecting box 60 is released downwardly also from the bottom surface of the filter device 1 installed on the rear side.

According to the present oxygen enriching apparatus 100, the filter device 1 is housed in the extremely narrow space on the rear side. Thus, the whole apparatus can be configured in an extremely compact manner. Furthermore, dust gathered by the filter of the filter device 1 is automatically cleaned by the rotation of the filter and accumulated in the dust collecting box 60. Thus, the exhaust from the oxygen enriching apparatus 100 contains no dust. Since it is only necessary for a user to detach the dust collecting box 60 and discard the dust periodically, daily work burden can be reduced. Moreover, since all emissions are performed on the bottom surface side in the present oxygen enriching apparatus 100, no exhaust directly flows toward the user. Thus, comfortable use environment can be achieved. Moreover, since a gas from which dust has been temporarily removed can be supplied into the housing 110 by the filter device 1, the life of the HEPA filter 130 installed in the housing 110 can be prolonged.

Moreover, according to the filter device 1, the operation sound of the blower 132 or the compressor 134 in the housing 110 is less likely to leak to the outside. Consequently, the quietness of the oxygen enriching apparatus 100 can be enhanced considerably.

While the planar surface of the filter 10 is disposed to align with the vertical direction in the filter device 1 of the present embodiment described above, the present invention is not limited thereto. Alternatively, for example, the filter 10 may be disposed so that the rotation axis thereof aligns with the vertical direction.

In the above-described embodiment, the bottom surface 38B of the insertion space 38A of the dust collecting box 60 is opened (in a lattice pattern), and all gas passing through the dust collecting box 60 passes through the collection filter 60B on the bottom surface to be exhausted from the bottom surface 38B of the insertion space 38A. The present invention, however, is not limited thereto.

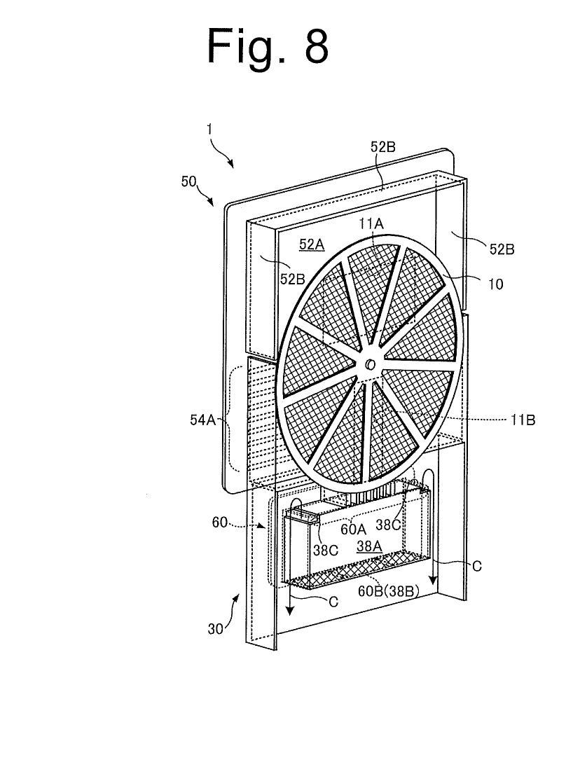

In addition to the bottom surface 38A of the insertion space 38A corresponding to the collection filter 60B, an emergency exhaust port 38C is preferably formed at another place, for example, as shown in FIG. 8. In particular, the exhaust port 38C is preferably formed on an upper surface side of the insertion space 38A, specifically, at a place corresponding to the gas intake port 60A of the dust collecting box 60. Consequently, a bypass path as indicated by an arrow C is formed. If the collection filter 60B is clogged by dust, a gas entering the dust collecting box 60 can be exhausted via the gas intake port 60A and the exhaust port 38C.

In such a case, the opening area of the exhaust port 38C is preferably made smaller than the area of the collection filter 60B or the bottom surface 38B so that large part of the gas is actively exhausted from the collection filter 60B under normal conditions.

The present invention is not limited to the above-described embodiments, and it is obvious that various modifications are possible within the scope departing from the gist of the present invention.

### REFERENCE SIGNS LIST

1 filter device
10 filter
11A dust gathering region
11B cleaning region
18 main flow channel
22 branch flow channel
30 first channel forming member
50 cover member
60 dust collecting box
70 operation detecting means
80 second flow channel forming member

1. A filter device comprising:
a main flow channel through which a gas flows;
a disc-shaped filter disposed on the main flow channel, with the gas passing through the disc-shaped filter in one direction;
a motor configured to rotate the filter; and
a branch flow channel disposed downstream of the filter in the main flow channel, the branch flow channel being configured to allow part of the gas in the main flow channel to branch off and allow the branched gas to pass through the filter in the other direction that is opposite to the one direction with respect to the filter, wherein
rotation of the filter moves dust collected by the filter in a dust gathering region where the filter and the main flow channel overlap with each other to a cleaning region where the filter and the branch flow channel overlap with each other, so that the dust is disengaged from the filter.

2. The filter device according to claim 1, wherein a region downstream of the cleaning region in the branch flow channel extends in a planar direction of the filter.

3. The filter device according to claim 2, wherein
the filter is disposed so that a rotation axis thereof is directed horizontally, and
the region downstream of the cleaning region in the branch flow channel extends in a vertical direction.

4. The filter device according to claim 1, wherein a region upstream of the dust gathering region in the main flow channel extends in a planar direction of the filter.

5. The filter device according to claim 4, wherein
the filter is disposed so that a rotation axis thereof is directed horizontally, and
the region upstream of the dust gathering region in the main flow channel extends in a vertical direction.

6. The filter device according to claim 1, wherein
a region upstream of the dust gathering region in the main flow channel extends in a planar direction of the filter,
a region downstream of the cleaning region in the branch flow channel extends in the planar direction of the filter, and
the main flow channel and the branch flow channel extending in the planar direction of the filter at least partially overlap with each other as viewed in an orthogonal direction to the rotation axis of the filter.

7. The filter device according to claim 1, wherein the gas and the dust are released vertically downward at downstream of the branch flow channel.

8. The filter device according to claim 1, wherein
a dust collecting box is detachably disposed downstream of the cleaning region in the branch flow channel, and
a collection filter configured to allow the gas to pass therethrough and gather the dust is disposed in the dust collecting box.

9. The filter device according to claim 8, wherein the collection filter constitutes a bottom surface of the dust collecting box.

10. The filter device according to claim 1, comprising a main flow channel cover unit disposed upstream of the filter in the main flow channel to face the dust gathering region with a distance from the filter, and wherein
the main flow channel cover unit guides a gas on an upstream side in the main flow channel in a planar direction of the filter.

11. The filter device according to claim 10, wherein
the main flow channel cover unit is detachably disposed, and
disengagement of the main flow channel cover unit causes at least part of the filter to be exposed to outside.

12. The filter device according to claim 1, comprising a guide unit disposed closely to face the filter at a place upstream of the filter in the main flow channel and not overlapping with the dust gathering region, and wherein
the guide unit guides the gas in the main flow channel in a planar direction of the filter to the dust gathering region.

13. The filter device according to claim 1, comprising a branch channel cover unit disposed downstream of the filter in the branch flow channel to face the cleaning region with a distance from the filter, and wherein
the branch channel cover unit guides a gas on a downstream side in the branch flow channel in a planar direction of the filter.

14. The filter device according to claim 1, comprising:
a suction space disposed downstream of the filter in the main flow channel;
a pressurization space disposed downstream of the suction space in the main flow channel; and
gas transfer means configured to transfer a gas in the suction space to the pressurization space, and wherein
branching of the branch flow channel is formed in the pressurization space.

15. An oxygen enriching apparatus equipped with the filter device according to claim 1.
